(19) United States
(12) Patent Application Publication
(10) Pub. No.: US 2013/0038494 A1
(43) Pub. Date: Feb. 14, 2013

(54) ADJUSTABLE ANTENNA APPARATUS AND METHODS

(71) Applicant: Reetta Kuonanoja, Oulu (FI)

(72) Inventor: Reetta Kuonanoja, Oulu (FI)

(21) Appl. No.: 13/505,734

(22) PCT Filed: Oct. 20, 2010
(86) PCT No.: PCT/FI2010/050821

§ 371 Date: Oct. 2, 2012

(30) Foreign Application Priority Data
Nov. 3, 2009 (FI) 20096134

(51) Int. Cl. H01Q 1/50; H01Q 13/10

(52) U.S. Cl. 343/746; 343/745

(57) ABSTRACT

An adjustable monopole antenna apparatus and methods. In one embodiment, the antenna apparatus is intended for mobile terminals. In an exemplary implementation, there is an adjusting point is provided, from which a conductor is branched to an adjusting circuit. The adjusting circuit comprises a switch and alternative reactive elements connected to ground, selectable by the switch. When a reactive element is changed, the electric length and resonance frequency of the radiator change, and the corresponding operating band shifts. If the antenna is configured as a dual-band antenna, the above-mentioned operating band is the lower band. One or more higher operating bands are based e.g. on radiating slots implemented by the same radiator conductor. The operating band of the exemplary embodiment of the antenna below the frequency 1 GHz can be shifted in a wider range than in the corresponding known antennas.

The invention relates to an adjustable monopole antenna especially intended for mobile terminals.

The adjustability of an antenna means in this description that a resonance frequency or frequencies of the antenna can be changed electrically. The aim is that the operating band of the antenna around a resonance frequency always covers the frequency range, which the operation requires at each time. There are different causes for the need for adjustability. When a portable radio device such as a mobile terminal is very small-sized, the space available for the antenna of the device is correspondingly small, which results in that the antenna's bandwidths are relatively narrow. Then, as the terminal is intended to function in several systems having frequency ranges relatively close to each other, it is difficult or impossible to cover frequency ranges used by more than one radio system. Correspondingly, securing the function that conforms to specifications in both transmitting and receiving bands of a single system can become more difficult. If the system uses sub-band division, it is advantageous from the point of view of the radio connection quality if the resonance frequency of the antenna can be tuned in a sub-band being used at each time.

In a dual-band antenna said problem concerns particularly the lower operating band, which is then more difficult than the higher operating band to make wide enough. In practice, it has often to cover the frequency range, which is used by the systems GSM850 and GSM900 (Global System for Mobile telecommunications) together, that range being 824-960 MHz. Also devices, which function in so-called LTE system (Long Term Evolution) as well, are being introduced to the market. In the LTE standard bands have been specified in the frequency range 698-798 MHz, which widens the total range of the antenna's lower operating band to 698-960 MHz. However, no extra space, which would be very much needed, is available for the antenna. For these reasons this description concerns primarily the implementation of the lower operating band.

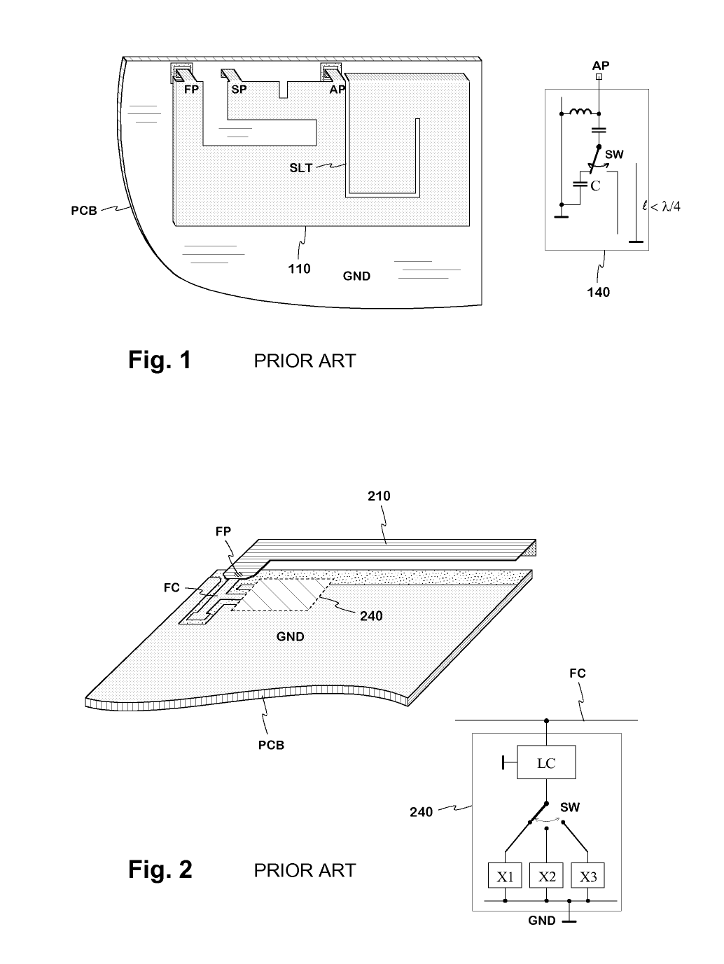

In the invention the adjustment of the antenna is carried out by means of a switch. The use of a switch for the aim in question is well known as such, as examples the solutions in FIGS. 1 and 2.

In FIG. 1 there is an arrangement, known from the publication WO 2007/012697, in which a switch is used for the shift of the antenna's operating bands. The antenna is of planar type, and it has been drawn as seen from above, or from the side of the radiating plane. The circuit board PCB of a radio device is seen below the radiating plane 110, the conductive upper surface of which board is signal ground GND and functions also as the ground plane of the antenna. The short-circuit conductor of the antenna joins the radiating plane at the short-circuit point SP, and the feed conductor at the feed point FP. In addition, a conductor of the antenna adjusting circuit 140 joins galvanically the radiating plane at the adjusting point AP. All three points are located at the same long side of the radiating plane, the short-circuit point being therebetween. The antenna has a lower and a higher operating band. The lower operating band is based on the resonator constituted by the whole radiating plane 110 and the ground plane, and the higher operating band is based on the slot radiator, the slot SLT of which starts from the edge of the radiating plane, beside the adjusting point AP.

The adjusting circuit 140 of the antenna is presented as a circuit diagram. The adjusting circuit comprises a multiple-way switch SW and reactive structural parts. The common terminal, or input, of the multiple-way switch is connected to the adjusting point AP of the radiating plane. The switch has two change-over terminals, or outputs, one of which is connected through a serial capacitor to a short transmission line short-circuited at its opposite end. The other output of the switch is connected to another short transmission line which is open at its opposite end. Changing the switch state changes the resonance frequencies of the antenna and thus the places of its operating bands. The adjusting circuit 140 is designed so that when the radiator is connected to the short-circuited transmission line, the whole adjusting circuit is ‘seen’ from the radiator as a very short short-circuited transmission line at the frequencies of the lower operating band. This means a low impedance. At the frequencies of the higher operating band the adjusting circuit is ‘seen’ as a short-circuited transmission line with the length about of quarter wave, which means a high impedance. When the radiator is connected to the open transmission line, the whole adjusting circuit is ‘seen’ from the radiator as a very short open transmission line at the frequencies of the lower operating band, which means a high impedance. At the frequencies of the higher operating band the adjusting circuit is ‘seen’ as an open transmission line with the length of about a quarter wave, which means a low impedance. The changes are caused, besides by the design of the adjusting circuit, also by the fact that the higher operating band is located at about double frequencies compared to the lower one.

The impedance changes result in that the lower operating band shifts downwards and the higher operating band upwards, when the switch output is changed from the short-circuited line to the open line. The lengths of the shifts are arranged by choosing the electric distance between the short-circuit point SP and adjusting point AP suitably. In the former state the lower operating band is intended to cover the frequency range 880-960 MHz of the EGSM system (Extended GSM) and the higher operating band the frequency range 1710-1880 MHz of the GSM1800 system. In the latter state of the switch the lower operating band is intended to cover the frequency range 824-894 MHz of the GSM850 system and the higher operating band the frequency range 1850-1990 MHz of the GSM1900 system. However, these aims will not be achieved, if the antenna's height may be e.g. 4 mm at the most due to lack of space. In this case the adjusting circuit has to be enlarged so that the lower operating band can at a time be set only at the transmitting or receiving band of the GSM850 system, for example. However, an unfavourable result is that the efficiency of the antenna structure degrades because of the increased switching losses.

In the solution of FIG. 1 the sufficient width of the higher operating band may require adding a parasitic element to the structure. In this case the total number of the contacts between the radiators and circuit board would be four, which means significant costs in the production.

FIG. 2 shows an arrangement including a switch, known from the publication WO 2007/042615. A portion of the circuit board PCB of a radio device is seen in the figure. The antenna is of ILA type (Inverted-L Antenna) and it has one band. Its monopole radiator 210 is a plate-like and rigid sheet metal strip, which has been connected to the antenna feed conductor FC at the feed point FP being located near a corner of the circuit board. The radiator is directed from that point first over the edge of the end of the circuit board outside the board and turns after that, still level with the upper surface of the circuit board, in the direction of the end. On the circuit board there is the signal ground GND, which functions as the antenna's ground plane, at a certain distance from the radiator 210. On the circuit board, at the end on the radiator side, there is the adjusting circuit 240 of the antenna. The adjusting circuit is marked on the circuit board as an area confined by a broken line and shown as a block diagram in the side drawing. From this drawing it appears that the adjusting circuit has been connected between the antenna feed conductor FC and the signal ground GND. The adjusting circuit comprises an LC circuit, a multiple-way switch SW and three alternative reactive structure parts X1, X2, X3. The LC circuit has been connected to the feed conductor at its one end and to the switch input at its other end. Its aim is to attenuate the harmonic frequency components being generated in the switch and to function as an ESD protector (Electrostatic Discharge) of the switch. The switch SW has three outputs, at a time to one of which the switch input can be connected. Each output of the switch has been fixedly connected to one of said reactive structure parts, the reactances of which exist against the signal ground. The interchanging of the reactance by controlling the switch changes the resonance frequency of the antenna and thus the place of its operating band. The operating band of the antenna has then three alternative places in this case.

A disadvantage of the solution in FIG. 2 is that good band characteristics and sufficient efficiency demand a remarkably long distance between the radiator and ground plane GND. This again means that the space requirement for the antenna still is, also in this case, stricter than desired. If it has to resign to a small space, the shift range of an operating band may remain too small.

The object of the invention is to implement a small-sized adjustable antenna in a new and advantageous way. An antenna according to the invention is characterized by what is specified in the independent claim 1. An antenna component according to the invention is characterized by what is specified in the independent claim 5. Some advantageous embodiments of the invention are presented in the other claims.

The basic idea of the invention is as follows: The antenna is implemented as monopole type. About halfway along its radiator conductor there is an adjusting point, from which a conductor is branched to the adjusting circuit of the antenna. The adjusting circuit comprises a switch and alternative reactive elements connected to the ground, selectable by the switch. When a reactive element is changed, the electric length and resonance frequency of the whole radiator change, in which case the corresponding operating band shifts. If the antenna is made a dual-band one, the above-mentioned operating band is the lower one of them. The higher operating band again is based e.g. on a radiating slot implemented by the same radiator conductor and a possible separate parasitic radiator.

An advantage of the invention is that the operating band of the antenna below the frequency 1 GHz can be shifted in a wider range than in the corresponding known antennas. This is due to the fact that the adjusting point of the antenna is located in the monopole radiator at a certain minimum distance from its feeding end. Another advantage of the invention is that the space required for the antenna inside the radio device is small.

The invention is below described in detail. In the description, reference will be made to the accompanying drawings, where

FIG. 1 presents an example of the adjustable antenna according to the prior art,

FIG. 2 presents a second example of the adjustable antenna according to the prior art,

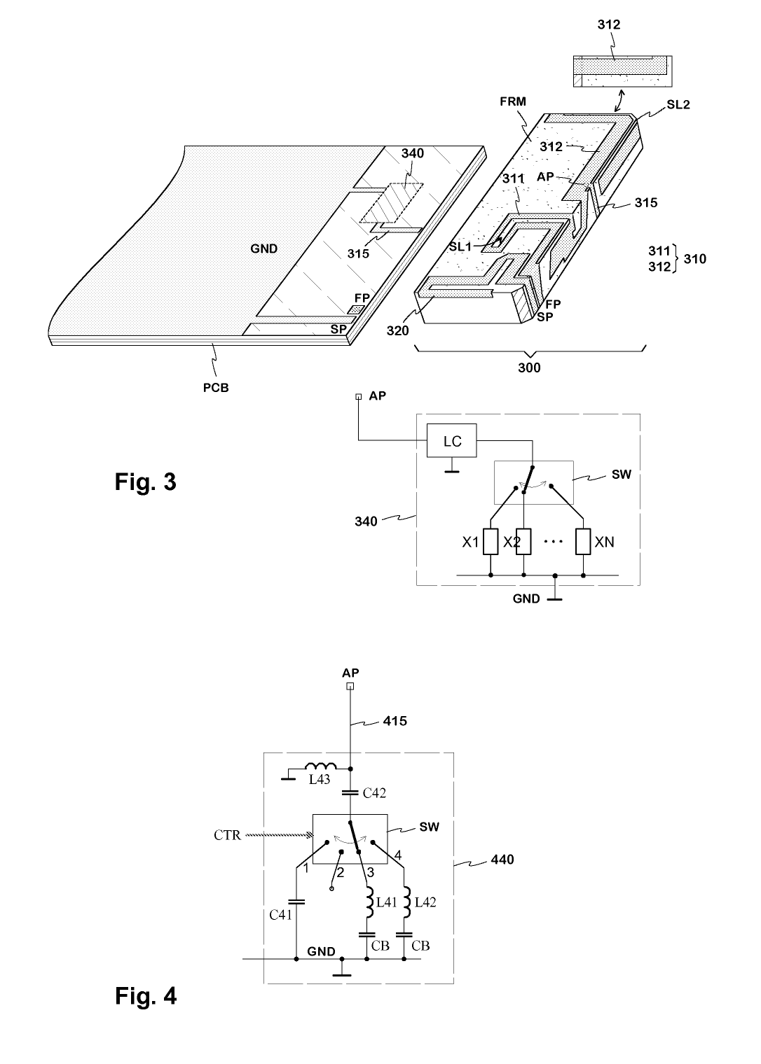

FIG. 3 presents an example of the adjustable antenna according to the invention,

FIG. 4 presents an example of the adjusting circuit of an antenna according to the invention,

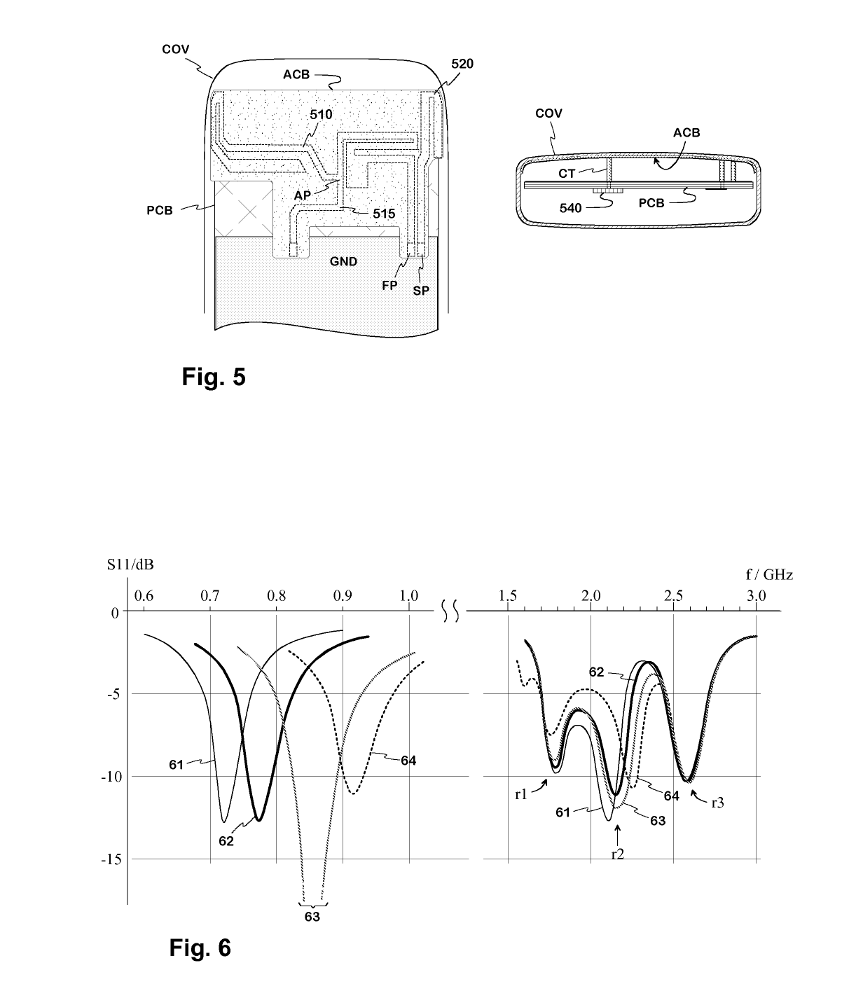

FIG. 5 presents a second example of the adjustable antenna according to the invention, and

FIG. 6 presents an example of the band characteristics of an antenna according to the invention.

FIGS. 1 and 2 were already described in conjunction with the description of the prior art.

In FIG. 3 there is an example of the antenna according to the invention. The antenna is located at one end of the circuit board PCB of a radio device. The radiating conductors are of conductive coating of the dielectric antenna frame FRM, which is here a box with relatively thin walls. The frame FRM and the radiating conductors constitute an antenna component 300, which is attached on the surface of the circuit board, where the ground plane GND is located. In the figure the antenna component has been drawn apart from the circuit board for the sake of clarity.

In the example the antenna has two operating bands, the lower one of which is based on the resonance of the conductor of the monopole radiator 310. The feed point FP of the antenna is at one end of the monopole radiator 310, which end is here called the first end. An intermediate conductor 315 branches from the monopole radiator to the adjusting circuit 340 of the antenna. In this description and claims the branching point is called the adjusting point AP of the antenna. The adjusting circuit is located on the circuit board PCB in the inner space of the antenna frame FRM. A part of the intermediate conductor 315 is thus on the circuit board. The adjusting point divides the radiating conductor in question in two parts, the first part 311 between the first end and the adjusting point and the second part 312 between the adjusting point and the tail end.

The edge of the ground plane is aside the antenna component 300. Alternatively, the ground plane can extend at least to some extent under the antenna component.

The adjusting circuit 340 is in principle similar to the one in FIG. 2. Thus it comprises a multiple-way switch SW and a reactive element X1-XN between its each change-over terminal and the ground plane, or ground GND. The common terminal of the switch is connected to said adjusting point AP through an LC circuit, which functions as an ESD protector. Therefore, one reactive element at a time is a part of the circuit between the adjusting point and ground, depending on the state of the switch. Changing the reactive element by controlling the switch changes the antenna's resonance frequency, which correspond to the lower operating band, and thus the place of this operating band.

It is substantial in the invention that the adjusting point AP is not located right at the first end nor at the tail end of the radiating conductor. In FIG. 3 the adjusting point is located about halfway along the radiator conductor. More generally it can be said that the distance of the adjusting point from the feed point FP, measured along the middle line of the radiating conductor, is 0.1 l . . . 0.9 l, in which l is the length of this middle line. In this case the effect of the adjustment is made good, that is the shift range of the operating band is made wide enough. The optimal point naturally depends on the case, in other words, what kind of device the antenna is made for and what kind the structure itself is made. When designing the shifting steps of the operating band, the parameters are, besides the location of the adjusting point, the reactances of the reactive elements, the length and width of the intermediate conductor 315 and the place of the adjusting circuit. Also the inductance of the coil in said LC circuit can be utilized as a design parameter.

For implementing the higher operating band of the antenna the monopole radiator 310 has been shaped so that there are two slot radiators in it. The first part 311 of the monopole radiator rises from the feed point FP, which is near the first end of the antenna component 300, through the side surface of the frame FRM to its upper surface, makes there a pattern, returns back to the side surface and then again to the upper surface towards the adjusting point AP. A first slot SL1 with a U-shape remains between the successive portions of the first part. The second part 312 of the monopole radiator runs from the adjusting point along an edge of the upper surface of the frame to the second end of the antenna component, turns there to the direction of the head, continues then on the side of the head surface and further on said side surface next to its starting point, or the adjusting point AP. A second slot SL2 remains between the successive portions of the second part 312. The first and second slot are designed so that oscillation with different frequencies is excited in them, which both frequencies nevertheless are located in the range of the higher operating band. in accordance with the explanation afore, in the example of FIG. 3 the adjusting point AP is located between the radiator area, where the first slot SL1 is, and the area, where the second slot SL2 is.

The antenna shown in FIG. 3 includes also a parasitic element 320 which is a conductor strip at the first end of the antenna component. The parasitic element is connected to the ground plane GND from the short-circuit point SP which is located next to the feed point FP on the circuit board PCB. The starting end of the parasitic element and the starting end of the first part of the monopole radiator are close to each other so that there is a significant electromagnetic coupling between them. By a suitable design an oscillation can be excited in the parasitic element e.g. at a frequency in the higher operating band.

FIG. 4 shows an example of the adjusting circuit in the antenna according to the invention. The number of the alternative reactive elements in the adjusting circuit 440 is four. The first reactive element is a capacitor C41, which is then between the first change-over terminal of the multiple-way switch SW and the signal ground, or ground plane GND. Correspondingly, the second ‘reactive element’ is an open circuit, thus representing a very high reactance, the third reactive element is a coil L41 and the fourth reactive element is a coil L42. In series with these coils there are blocking capacitors CB to break the direct current circuit from the control of the switch. The capacitance of the blocking capacitors is so high, e.g. 100 pF, that they constitute almost a short-circuit at the antenna's use frequencies.

Between the common terminal of the switch SW and the intermediate conductor 415 leading to the adjusting point AP there is a capacitor C42, and between this capacitor's end on the side of the adjusting point and the ground plane there is a coil L43. The LC circuit C42-L43 functions as an ESD protector of the switch. In addition, the capacitor C42 functions as a blocking capacitor preventing the forming of a direct current circuit from the control of switch to the ground through the coil L43 or the radiator. The state of the switch is set by the control signal CTR.

FIG. 5 shows another example of the antenna according to the invention. The antenna comprises a monopole radiator 510, a parasitic element 520, an intermediate conductor 515, an adjusting circuit 540 and ground plane GND as in the example of FIG. 3. The intermediate conductor branches from the monopole radiator at the adjusting point AP, which is located relatively far from both the first and the tail end of the radiating conductor. In this case the monopole radiator, intermediate conductor and parasitic element are of conductive coating of a thin dielectric plate, and they all together constitute a flexible antenna circuit board ACB. The antenna circuit board is attached on the inner surface of the outer cover COV of a radio device, and it follows the cover's shape. The contact pads on the antenna circuit board are connected to the circuit board PCB of the radio device by contacts, like the contact CT functioning as a part of the intermediate conductor 515. In the example the adjusting circuit 540 is located on the opposite side of the circuit board PCB. The ground plane GND is a part of the conductive upper surface of the circuit board PCB.

FIG. 6 shows an example of the band characteristics of the antenna according to invention. The measured prototype is like the one in FIG. 3 and the adjusting circuit is like the one in FIG. 4. In the adjusting circuit the first reactive element C41=0.3 pF, the third reactive element L41=15 nH and the fourth reactive element L42=3.9 nH. Curve 61 shows the fluctuation of the reflection coefficient S11 of the antenna as a function of frequency, when the switch is in state 1, or its common terminal is connected to the first reactive element, curve 62 shows the fluctuation of the reflection coefficient, when the switch is in state 2, curve 63 shows the fluctuation of the reflection coefficient, when the switch is in state 3, and curve 64 shows the fluctuation of the reflection coefficient, when the switch is in state 4.

It is seen from the curves that the total shift of the lower operating band of the antenna is about 200 MHz and the total bandwidth is more than 280 MHz, if the value −5 dB of the reflection coefficient is regarded as criterion for the boundary frequencies of the band. By this criterion the lower operating band is about 690-760 MHz when the switch is in state 1, about 735-825 MHz when the switch is in state 2, about 800-894 MHz when the switch is in state 3 and about 875-975 MHz when the switch is in state 4. In switch's state 3 the operating band well covers the frequency range 824-894 MHz of the GSM850 system, and in state 4 it well covers the frequency range 890-960 MHz of the GSM900 system.

The higher operating band of the antenna in the example is very wide, about 1.7-2.7 GHz, from which the range 2.3-2.4 GHz is a bit poor. The higher operating band is based on three resonances: the resonance r1 of the parasitic element, the frequency of which is about 1.8 GHz, the resonance r2 of the second slot radiator formed by the monopole radiator, the frequency of which is about 2.2 GHz, and the resonance r3 of the first slot radiator, the frequency of which is about 2.6 GHz. The state of the switch in the adjusting circuit naturally affects a little also the higher operating band, but this effect is non-essential.

The adjustable antenna according to the invention has been described above. Naturally, its structure can in details vary from that presented. The shapes of the radiating elements of the antennas can vary widely. Also the implementation of the reactive elements in the adjusting circuit can vary. At least a part of them can be also short planar transmission lines on the surface of the circuit board. The invention does not limit the manufacturing method of the antenna. For example, said antenna frame can be a part of the outer cover of the radio device or the radiators can be on the surface of a chip type substrate. The inventive idea can be applied in different ways within the scope defined by the independent claims 1 and 5.

1-6. (canceled)

7. An adjustable antenna, comprising:
a ground plane;
a monopole type radiator with a feed point and first and second slots;
an adjusting circuit configured to enable adjustment of at least one operating frequency of the antenna; and
an adjusting point in communication with the radiator and the adjusting circuit;
wherein the adjusting point is disposed substantially between the first and second slots.

8. The antenna of claim 7, further comprising a substantially rectangular dielectric support element having first and second distal ends, the feed point disposed towards the first distal end of the element, and the adjusting point disposed substantially central along a longitudinal axis of the dielectric element.

9. The antenna of claim 7, wherein the first and second slots are configured to each individually radiate and receive electromagnetic energy in a first frequency band, and the radiator is configured to radiate and receive electromagnetic energy in a second frequency band, the second band being lower in frequency than the first band.

10. The antenna of claim 9, further comprising a parasitic radiator element, at least a portion of the parasitic element disposed proximate the feed point so as to induce substantial electromagnetic coupling therebetween.

11. The antenna of claim 10, wherein the parasitic element is configured to operate substantially within the first frequency band.

12. The antenna of claim 7, further comprising a parasitic radiator element, at least a portion of the parasitic element disposed proximate the feed point so as to induce substantial electromagnetic coupling therebetween.

13. The antenna of claim 7, further comprising a conductor connecting the adjusting point to the adjusting circuit, the conductor being configured to function as a reactance having a certain value, the certain value selected to optimize shifting of at least one operating band of the antenna.

14. The antenna of claim 7, wherein the adjusting circuit comprises:
at least two reactive elements; and
a multi-way switch in switchable communication with the at least two reactive elements;
wherein the switch is configured to selectively place one of the at least two reactive elements in electrical communication with the adjusting point and the ground plane so as to set an operating band of the antenna to a desired value or range.

15. The antenna of claim 14, wherein said operating band is below a frequency of 1 GHz.

16. An antenna component, comprising:
a dielectric element having at least a first end and a second end;
at least one monopole radiator element disposed on at least one surface of the dielectric element, the at least one radiator configured to implement a first operating band of the antenna;
a feed point disposed towards the first end of the dielectric element; and
an adjustment point disposed between the feed point and the second end of the dielectric element, the adjustment point being configured to enable shifting of at least one frequency band associated with the radiator element.

17. The antenna component of claim 16, further comprising a parasitic element disposed on said at least one surface and configured to parasitically couple to at least a portion of said at least one radiator so as to widen a second operating band of the antenna.

18. The antenna component of claim 16, wherein said at least one radiator comprises first and second slots formed therein, the first and second slots configured to cause respective first and second portions of said at least one radiator to radiate in a second operating band.

19. A method of operating an adjustable antenna, the antenna comprising a monopole radiator element having at least first and second portions, and an adjustment point disposed substantially at an intersection of the first and second portions, the method comprising altering a reactance in electrical communication with the adjustment point so as effect a shift of a frequency band of the monopole radiator element.

20. The method of claim 19, wherein the monopole radiator element further comprises first and second portions with respective first and second slots, the first and second portions and respective slots configured to radiate within respective frequency bands which are each greater in frequency than said frequency band of said monopole radiator element, and the method further comprises utilizing said first and second portions and respective slots to radiate within said respective frequency bands.

21. The method of claim 20, wherein the antenna further comprises a parasitic radiator element disposed proximate at least a portion of the monopole radiator element, and the method further comprises utilizing said parasitic element to radiate within a frequency band higher than said frequency band of said monopole radiator element.

22. A method of configuring an adjustable antenna for a particular mobile device application, the antenna including a monopole radiator having first and second portions formed on a dielectric element, and a feed point, the method comprising:
selecting, based at least in part on said application:
a location of a frequency band adjustment point relative to the feed point and first and second portions;
one or more reactances associated with an adjusting circuit electrically communicating with the adjustment point; and
a configuration of a conductor coupling the adjusting circuit with the adjustment point.

23. The method of claim 22, further comprising selecting, based at least in part on said application, a location of said adjusting circuit relative to at least one of: (i) said dielectric element; and/or (ii) said monopole radiator.

24. The method of claim 22, wherein the conductor further comprises a circuit having at least one inductance, and the method further comprises selecting, based at least in part on said application, a value of the at least one inductance.

25. The method of claim 22, further comprising selecting, based at least in part on said application, a size and shape of said dielectric element, and thereby at least a portion of a configuration of said monopole radiator.

26. An adjusting circuit for use in an adjustable antenna, the circuit comprising:
a multiple position switching apparatus;
a first conductor for electrically coupling the switching apparatus to an antenna radiating element through at least one first electrical component;
a plurality of second conductors for electrically coupling respective ones of the multiple positions of the switching apparatus to ground through respective at least one second electrical components; and
an inductance in communication with said first conductor.

27. The adjusting circuit of claim 26, wherein said at least one first electrical components and said at least one second electrical components each comprise blocking capacitors.

28. The adjusting circuit of claim 27, further comprising at least one inductor in electrical series with at least one of said blocking capacitors in at least one of said second conductors between said switch apparatus and said ground.

29. A wireless mobile device, comprising:
a housing comprising an interior cavity;
a radio frequency transceiver;
an adjustable antenna in signal communication with the transceiver;
a first substrate disposed within said housing interior cavity and comprising a monopole antenna radiator disposed on at least one surface thereof; and
a second substrate disposed within said housing interior cavity and having an adjusting circuit associated therewith, the adjusting circuit being in electrical communication with the antenna radiator.

30. The mobile device of claim 29, wherein the first substrate comprises a substantially flexible substrate having said antenna radiator plated thereon, said flexible substrate being disposed proximate to at least one surface of said housing and conforming substantially thereto.

31. The mobile device of claim 29, wherein the second substrate comprises said adjusting circuit mounted substantially thereon, said adjusting circuit being disposed in majority on a side of said second substrate that is not facing said first substrate.

32. The mobile device of claim 29, wherein the said antenna radiator comprises a first portion having a first slot formed therein, and a second portion having a second slot formed therein, and an adjusting contact region in communication with the adjusting circuit disposed at least partly between the first and second portions.

33. The mobile device of claim 32, wherein the radiator element as whole is configured to operate in a first frequency band, whereas the first and second portions thereof are configured to operate in a second frequency band greater in frequency than the first band.

34. The mobile device of claim 29, further comprising a parasitic radiator element formed substantially on said first substrate proximate said monopole radiator element.

35. An adjustable antenna comprising a ground plane, a monopole type radiator with a feed point at its first end and an adjusting circuit with at least two reactive elements and a multi-way switch, by which one reactive element at a time can be connected to be a part of the adjusting circuit between an adjusting point of the antenna and the ground plane so as to set an operating band of the antenna to a desired value or range;
characterized in that said adjusting point is located in the monopole type radiator at a distance l from a feed point measured along a middle line of a conductor of the radiator, l being a length of said middle line.

36. An adjustable antenna according to claim 35, characterized in that said operating band is below a frequency of 1 GHz.

37. An adjustable antenna according to claim 35, the monopole type radiator of which constitutes a first radiating slot and a second radiating slot configured to implement a higher operating band for the antenna;
characterized in that said adjusting point is located substantially between an area of the monopole radiator where the first radiating slot is disposed, and an area where the second radiating slot is disposed.

38. An adjustable antenna according to claim 35, characterized in that an intermediate conductor connecting the adjusting point to the adjusting circuit is configured to function as an inductance having a certain value, the certain value selected to optimize shifts of the operating band.

39. An antenna component for use in an adjustable antenna, the component comprising a dielectric object and at least one monopole type radiator disposed on at least one surface thereof, the at least one radiator configured to implement a lower operating band of the antenna, a first end of said radiator comprising a feed point of the antenna;
characterized in that the radiator comprises an adjusting point of the antenna, an intermediate conductor to be connected to an adjusting circuit of the antenna, the intermediate conductor branching from the adjusting point; and
wherein a distance of the adjusting point from the feed point is in the range of 0.1 l to 0.9 l measured along a middle line of the radiator, l being the total length of said middle line.

40. An antenna component according to claim 39, further comprising a parasitic element operatively coupled from its one end to a ground plane to widen an upper operating band of the antenna.
